(19) United States
(12) Patent Application Publication
(10) Pub. No.: US 2017/0171276 A1
(43) Pub. Date: Jun. 15, 2017

(54) Method, Electronic Device and System for Slicing Streaming Media Files

(71) Applicants: Le Holdings (Beijing) Co., Ltd, Beijing (CN); LeCloud Computing Co., Ltd., Beijing (CN)

(72) Inventors: Fengyu Liu, Beijjing (CN); Feng Han, Beijing (CN); Xiao Xu, Beijing (CN)

(21) Appl. No.: 15/246,437

(22) Filed: Aug. 24, 2016

Related U.S. Application Data
(63) Continuation of application No. PCT/CN2016/088871, filed on Jul. 6, 2016.

(30) Foreign Application Priority Data
Dec. 11, 2015 (CN) 201510921248.6

(51) Int. Cl. H04L 29/06; H04L 29/08

(52) U.S. Cl. CPC H04L 65/602; H04L 65/608; H04L 67/06; H04L 67/142

(57) ABSTRACT

Disclosed are a method, an electronic device and a system for slicing a streaming media file. At a control center, the method includes: scheduling a slicing task onto a master server to execute the slicing task; and scheduling the slicing task being executed by the master server onto a backup server to continue executing if the master server stops slicing. At a backup server, the method includes: receiving a scheduling instruction sent by a control center, wherein the scheduling instruction is used for instructing the backup server to continue executing a slicing task being executed on a master server; and continuing executing the slicing task scheduled from the master server in response to the scheduling instruction.

### CROSS REFERENCE TO RELATED APPLICATIONS

This application is a continuation of International Application No. PCT/CN2016/088871, filed on Jul. 6, 2016, which is based upon and claims priority to Chinese Patent Application No. 201510921248.6, filed on Dec. 11, 2015, the entire contents of all of which are incorporated herein by reference.

### TECHNICAL FIELD

The present disclosure relates to telecommunications technologies, and more particularly, to a method, an electronic device and a system for slicing a streaming media file.

### BACKGROUND

As one of multimedia, stream media, also known as streaming media, is media being transferred and being played. Playback of stream media is completed according to stream media transfer protocols. Common stream media transfer protocols include a Real Time Messaging Protocol (RTMP) protocol, a (Real Time Streaming Protocol) RTSP protocol, a Microsoft Media Server Protocol (MMS) protocol, and an HTTP Live Streaming (HLS) protocol, etc. In an HLS live broadcast implemented through the HLS protocol, what is acquired by a client is not a complete data stream. Instead, continuous and short-time slicing files are acquired by a server by slicing a live broadcast data stream according to the HLS protocol. The client constantly downloads and plays these slicing files. Since the server always generates new slicing files by using the latest live broadcast data, live broadcast can be implemented as long as the client ceaselessly plays in sequence slicing files acquired from the server.

In a cloud live broadcast system, one streaming media file is sliced by one slicing server. In case of a higher concurrency of slicing tasks, pressure of slicing servers is rapidly increased, which may likely cause a system breakdown of the slicing servers and cause interruption of slicing of the streaming media file, thereby leading to failure of continuous transmission of streaming media files.

### SUMMARY

The present disclosure provides a method, an electronic device and a system for slicing a streaming media file to solve a problem of failure of continuous transmission of streaming media files.

To solve the foregoing technical problem, in a first aspect, embodiments of the present disclosure provide a method for slicing a streaming media file, which is applied to a control center, including:

scheduling a slicing task onto a master server to execute the slicing task; and

scheduling the slicing task being executed by the master server onto a backup server to continue executing if the master server stops slicing.

In a second aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for slicing a streaming media file mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to :

receive a scheduling instruction sent by a control center, wherein the scheduling instruction is used for instructing the backup server to continue executing a slicing task being executed on a master server; and

continue executing the slicing task scheduled from the master server in response to the scheduling instruction.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 illustrates a flowchart of a first method for slicing a streaming media file in accordance with some embodiments;

FIG. 2 illustrates a flowchart of a second method for slicing a streaming media file in accordance with some embodiments;

FIG. 3 illustrates a flowchart of a third method for slicing a streaming media file in accordance with some embodiments;

FIG. 4 illustrates a composition block diagram of a first apparatus for slicing a streaming media file in accordance with some embodiments;

FIG. 5 illustrates a composition block diagram of a second apparatus for slicing a streaming media file in accordance with some embodiments;

FIG. 6 illustrates a composition block diagram of a third apparatus for slicing a streaming media file in accordance with some embodiments;

FIG. 7 illustrates a composition block diagram of a fourth apparatus for slicing a streaming media file in accordance with some embodiments;

FIG. 8 illustrates a composition block diagram of a system for slicing a streaming media file in accordance with some embodiments;

FIG. 9 illustrates a schematic structural diagram of an apparatus for slicing a streaming media file in accordance with some embodiments; and

FIG. 10 illustrates a block diagram of an electronic device which is configured to perform the methods for slicing a streaming media file in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

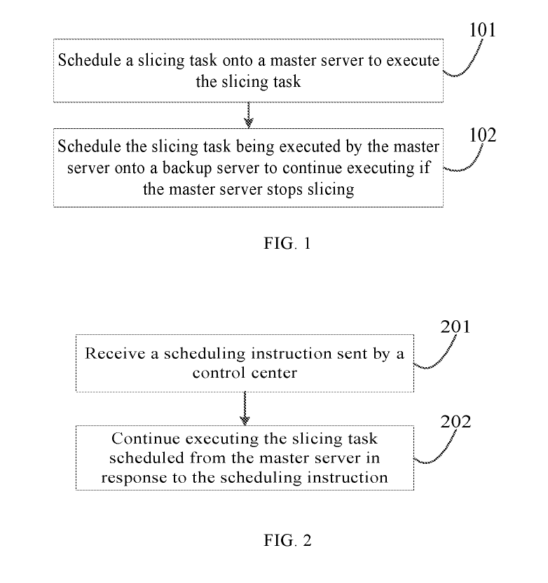

Embodiments of the present disclosure provide a method for slicing a streaming media file, which is applied to a control center. As shown in FIG. 1, the method includes:

101: A slicing task is scheduled onto a master server to execute the slicing task.

Transferring a streaming media file according to the HLS protocol is to slice the streaming media file into slicing files and then to transfer the slicing files one by one, thereby completing transmission of the streaming media file. A slicing task refers to slicing a streaming media file in a process of transmission of the streaming media file. A slicing task is executed by a dedicated slicing server.

A system for uploading and playing streaming media files includes many streaming media files and servers. When one streaming media file needs to be sliced, one server is required to slice the streaming media file. Slicing tasks of the whole system are scheduled by the control center, which can meet demands for slicing without wasting server resources. In this embodiment, scheduling methods of the control center are not limited.

The control center schedules a slicing task onto a master server to execute the slicing task by the master server. In this embodiment, slicing manners of the server are not limited.

102: The slicing task being executed by the master server is schedule onto a backup server to continue executing if the master server stops slicing.

As stream media are more and more widely used, more and more users start to use stream media, and more and more streaming media files need to be transferred. When the concurrency of slicing tasks is higher, a system breakdown may likely occur in the server, thus the server stops slicing and transmission of streaming media files may be interrupted.

To ensure transmission of streaming media files, the slicing task being executed by the master server is scheduled onto the backup server to continue executing if the master server stops slicing. Both the backup server and the master server can execute a slicing task. When the master server stops slicing, the backup server is started to execute a slicing task so as to ensure that the slicing task is continued executing. Continuous transmission of streaming media files can be ensured until slicing the streaming media files is interrupted.

According to the method for slicing a streaming media file provided by embodiments of the present disclosure, a control center schedules a slicing task, a master server executes the slicing task scheduled by the control center, the control center sends a scheduling instruction to a backup server if the master server stops slicing, and the backup server executes the slicing task in response to the scheduling instruction. Compared with the prior art, embodiments of the present disclosure can use a backup server, when a master server system breaks down, the backup server can continue completing a slicing task without interruption of slicing a streaming media file and can continuously transfer streaming media files.

Further, embodiments of the present disclosure further provide a method for slicing a streaming media file, which is applied to a backup server. As shown in FIG. 2, the method includes:

201: A scheduling instruction sent by a control center is received.

The scheduling instruction is used for instructing the backup server to continue executing a slicing task being executed on a master server. The scheduling instruction is sent from a control center to the backup server to schedule a slicing task.

202: The slicing task scheduled from the master server is continued executing in response to the scheduling instruction.

The backup server continues executing the slicing task scheduled from the master server in response to the scheduling instruction. The slicing task scheduled from the master server is a slicing task that has been stopped by the master server. The “continuing” in continuing executing a slicing task means that there is no interval between a last slicing file sliced by the master server for a streaming media file needing to be sliced and a first slicing file sliced by the backup server, where a slicing file is continuous data without loss.

According to the method for slicing a streaming media file provided by embodiments of the present disclosure, a control center schedules a slicing task, a master server executes the slicing task scheduled by the control center, the control center sends a scheduling instruction to a backup server if the master server stops slicing, and the backup server executes the slicing task in response to the scheduling instruction. Compared with the prior art, embodiments of the present disclosure can use a backup server, when a master server system breaks down, the backup server can continue completing a slicing task without interruption of slicing a streaming media file and can continuously transfer streaming media files.

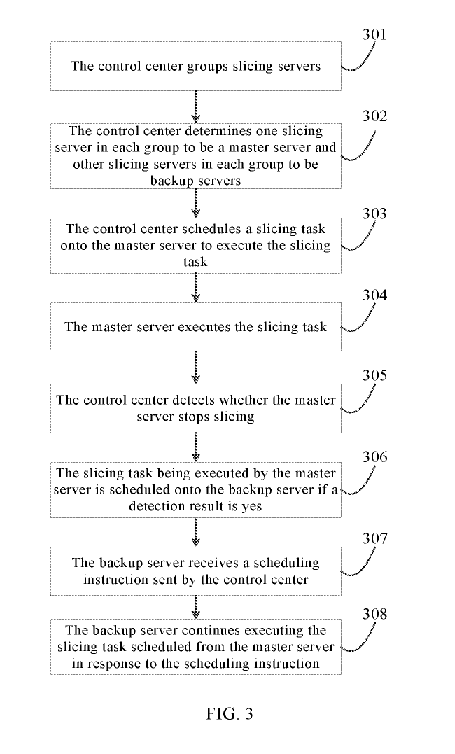

Further, as refinement and expansion of the method as shown in FIG. 1 or FIG. 2, embodiments of the present disclosure further provide a method for slicing a streaming media file, where the method relates to a control center, a master server and a backup server. As shown in FIG. 3, the method includes:

301: The control center groups slicing servers.

Slicing servers in a stream media system are grouped, and data interaction exists among slicing servers in the same group. Therefore, grouping slicing servers is based on a premise of making data interaction convenient. Each group has at least two slicing servers to ensure uninterrupted slicing of streaming media files. In this embodiment, the maximum quantity of slicing servers in each group is not limited.

302: The control center determines one slicing server in each group to be a master server and other slicing servers in each group to be backup servers.

One slicing server in each group is determined to be a master server, which may be any slicing server in each group.

303: The control center schedules a slicing task onto the master server to execute the slicing task.

When the control center receives a slicing task, the control center schedules the slicing task onto the master server and instructs the master server to execute the slicing task.

304: The master server executes the slicing task.

The master server slices a streaming media file. A slicing result generated by the master server is backed up into the backup server when the master server executes a slicing task so that the backup server continues executing slicing according to the slicing result when the slicing task is scheduled onto the backup server for executing. The slicing result carries sequence number information of fragmentation and fragmentation duration information so that the backup server continues slicing according to the sequence number information and the fragmentation duration information.

305: The control center detects whether the master server stops slicing.

Methods for detecting whether the master server stops slicing include: receiving an exception notification reported by the master server, where the exception notification is used for indicating that the master server stops slicing; or periodically sending a keepalive test request to the master server, and determining that the master server stops slicing if no keepalive response returned by the master server is received. Both the two detection methods can be used for detecting whether the master server stops slicing.

Regarding to receiving an exception notification reported by the master server, whether to report a normality notification is not limited in this embodiment. Regarding to periodically sending a keepalive test request to the server, the period of sending a keepalive test request is not limited in this embodiment.

306: The slicing task being executed by the master server is scheduled onto the backup server if a detection result is yes.

307: The backup server receives a scheduling instruction sent by the control center.

The scheduling instruction is used for instructing the backup server to continue executing the slicing task being executed on the master server.

308: The backup server continues executing the slicing task scheduled from the master server in response to the scheduling instruction.

The backup server continues executing the slicing task according to the slicing result. The slicing result carries sequence number information of fragmentation and fragmentation duration information; and slicing is continued according to the sequence number information and the fragmentation duration information.

The slicing result refers to a slicing result backed up into the backup server when the master server slices. Different streaming media files correspond to different slicing tasks, and different slicing tasks have different slicing results. In this embodiment, a slicing task refers to a slicing task of the same streaming media file, and a slicing result refers to a slicing result of the same slicing task.

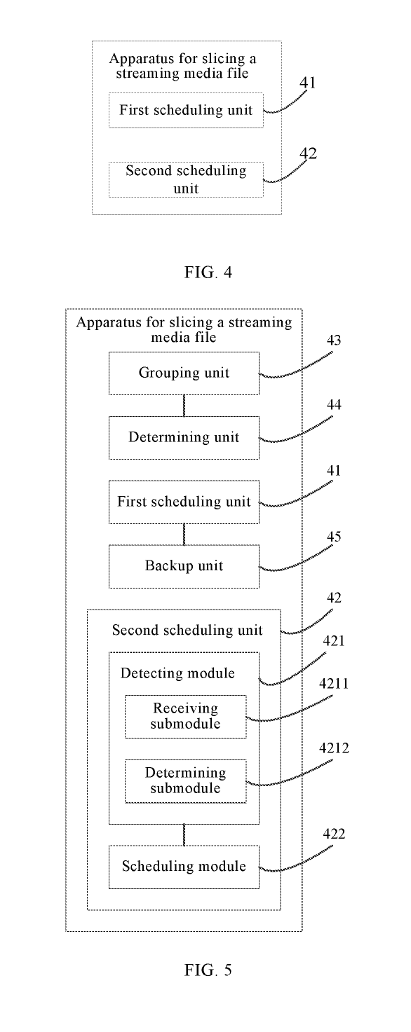

Further, as an implementation of the method as shown in FIG. 1 and FIG. 3, embodiments of the present disclosure further provide an apparatus for slicing a streaming media file, which is positioned at a control center or is independent of the control center but establishes a relation with the control center for data interaction. As shown in FIG. 4, the apparatus includes: a first scheduling unit 41 and a second scheduling unit 42, where

the first scheduling unit 41 is configured to schedule a slicing task onto a master server to execute the slicing task; and

the second scheduling unit 42 is configured to schedule the slicing task being executed by the master server onto a backup server to continue executing if the master server stops slicing.

Further, as shown in FIG. 5, the apparatus further includes:

a grouping unit 43, configured to group slicing servers before the first scheduling unit 41 schedules a slicing task onto a master server to execute the slicing task, where each group includes at least two slicing servers; and

a determining unit 44, configured to determine one slicing server in each group of the grouping unit 43 to be a master server and other slicing servers in each group to be backup servers.

Further, as shown in FIG. 5, the second scheduling unit 42 includes:

a detecting module 421, configured to detect whether the master server stops slicing; and

a scheduling module 422, configured to schedule the slicing task being executed by the master server onto the backup server to continue executing if a detection result of the detecting module 421 is yes.

Further, as shown in FIG. 5, the detecting module 421 includes:

a receiving submodule 4211, configured to receive an exception notification reported by the master server, where the exception notification is used for indicating that the master server stops slicing; and

a determining submodule 4212, configured to periodically send a keepalive test request to the master server, and determine that the master server stops slicing if no keepalive response returned by the master server is received.

Further, as shown in FIG. 5, the apparatus further includes:

a backup unit 45, configured to back up a slicing result generated by the master server into the backup server when the master server executes a slicing task so that the backup server continues executing slicing according to the slicing result when the slicing task is scheduled onto the backup server for executing.

Further, the slicing result backed up by the backup unit 45 carries sequence number information of fragmentation and fragmentation duration information so that the backup server continues slicing according to the sequence number information and the fragmentation duration information.

According to the apparatus for slicing a streaming media file provided by embodiments of the present disclosure, a control center schedules a slicing task, a master server executes the slicing task scheduled by the control center, the control center sends a scheduling instruction to a backup server if the master server stops slicing, and the backup server executes the slicing task in response to the scheduling instruction. Compared with the prior art, embodiments of the present disclosure can use a backup server, when a master server system breaks down, the backup server can continue completing a slicing task without interruption of slicing a streaming media file and can continuously transfer streaming media files.

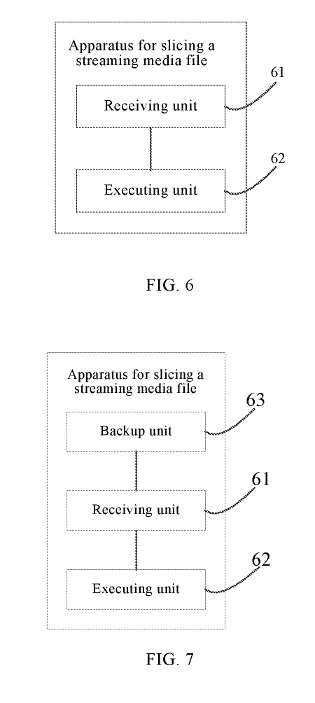

Further, as an implementation of the method as shown in FIG. 2 and FIG. 3, embodiments of the present disclosure further provide an apparatus for slicing a streaming media file, which is applied to a backup server or is independent of the server but establishes a relation with the server for data interaction. As shown in FIG. 6, the apparatus includes: a receiving unit 61 and an executing unit 62, where

the receiving unit 61 is configured to receive a scheduling instruction sent by a control center, where the scheduling instruction is used for instructing the backup server to continue executing a slicing task being executed on a master server; and

the executing unit 62 is configured to continue executing the slicing task scheduled from the master server in response to the scheduling instruction received by the receiving unit 61.

Further, as shown in FIG. 7, the apparatus further includes:

a backup unit 63, configured to back up a slicing result generated by the master server when the master server executes the slicing task before the receiving unit 62 receives the scheduling instruction sent by the control center; and

the executing unit 62, configured to continue executing the slicing task according to the slicing result backed up by the backup unit.

Further, as shown in FIG. 7, the slicing result backed up by the backup unit 63 carries sequence number information of fragmentation and fragmentation duration information; and

the executing unit 62 is configured to continue slicing according to the sequence number information and the fragmentation duration information.

According to the apparatus for slicing a streaming media file provided by embodiments of the present disclosure, a control center schedules a slicing task, a master server executes the slicing task scheduled by the control center, the control center sends a scheduling instruction to a backup server if the master server stops slicing, and the backup server executes the slicing task in response to the scheduling instruction. Compared with the prior art, embodiments of the present disclosure can use a backup server, when a master server system breaks down, the backup server can continue completing a slicing task without interruption of slicing a streaming media file and can continuously transfer streaming media files.

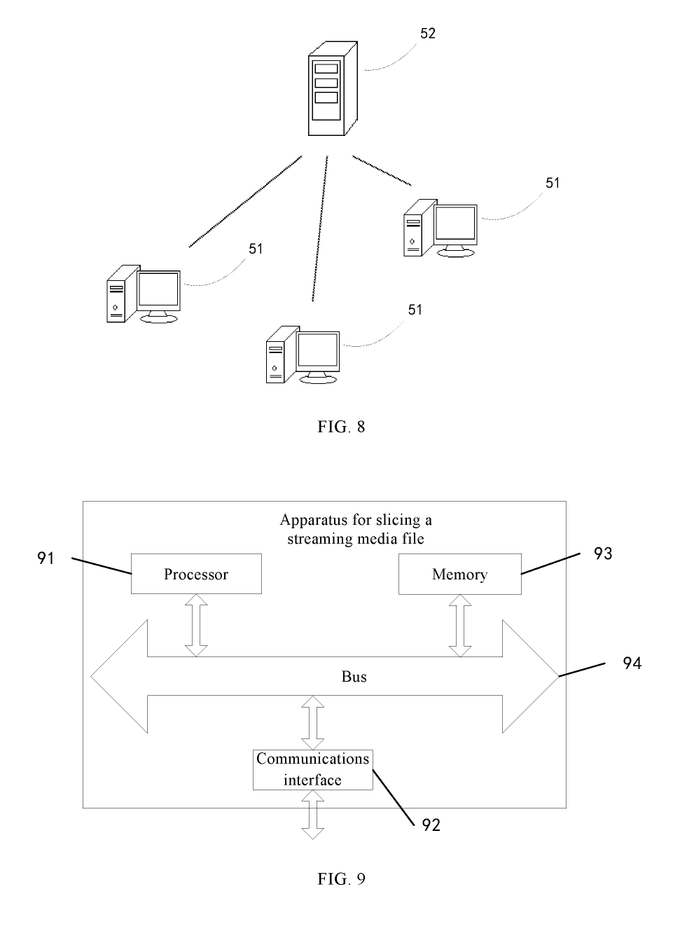

Further, as an implementation of the method as shown from FIG. 1 to FIG. 3, embodiments of the present disclosure further provide a system for slicing a streaming media file, as shown in FIG. 8, the system includes: a control center 81, a master server 82 and a backup server 83, where

the control center 81 is configured to schedule a slicing task;

the master server 82 is configured to execute the slicing task scheduled by the control center 81;

the control center 81 is further configured to send a scheduling instruction to the backup server 83 if the master server 82 stops slicing; and

the backup server 83 is configured to execute the slicing task in response to the scheduling instruction.

According to the system for slicing a streaming media file provided by embodiments of the present disclosure, a control center schedules a slicing task, a master server executes the slicing task scheduled by the control center, the control center sends a scheduling instruction to a backup server if the master server stops slicing, and the backup server executes the slicing task in response to the scheduling instruction. Compared with the prior art, embodiments of the present disclosure can use a backup server, when a master server system breaks down, the backup server can continue completing a slicing task without interruption of slicing a streaming media file and can continuously transfer streaming media files.

It is to be noted that in allusion to the foregoing apparatus for slicing a streaming media file, functions of each unit module used in the embodiments of the present disclosure can be implemented through a hardware processor.

Exemplarily, as shown in FIG. 9, which illustrates a schematic structural diagram of an apparatus for slicing a streaming media file according to embodiments of the present disclosure, the apparatus for slicing a streaming media file can include: a processor 91, a communications interface 92, a memory 93 and a bus 94, where the processor 91, the communications interface 92 and the memory 93 complete communications among each other through the bus 94. The communications interface 92 can be configured to implement information transmission between the server and the client. The processor 91 can invoke a logic instruction in the memory 93 to execute, at a control center, the following method: a slicing task is scheduled onto a master server to execute the slicing task, and the slicing task being executed by the master server is scheduled onto a backup server to continue executing if the master server stops slicing. At a backup server, the following method is executed: a scheduling instruction sent by a control center is received, where the scheduling instruction is used for instructing the backup server to continue executing a slicing task being executed on a master server, and the slicing task scheduled from the master server is continued executing in response to the scheduling instruction.

In addition, when a logic instruction in the foregoing memory 93 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for slicing a streaming media file mentioned by embodiments of the present disclosure.

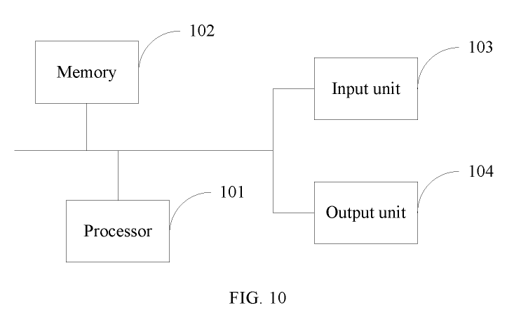

FIG. 10 is a block diagram of an electronic device which is configured to perform the methods for slicing a streaming media file according to an embodiment of the present disclosure. As shown in FIG. 10, the device includes:

one or more processors 101 and memory 102. A processor 101 is showed in FIG. 10 for an example.

Device which is configured to perform the methods for slicing a streaming media file can also include: input unit 103 and output unit 104.

Processor 101, memory 102, input unit 103 and output unit 104 can be connected by BUS or other methods, and BUS connecting is showed in FIG. 10 for an example.

Memory 102 can be used for storing non-transitory software program, non-transitory computer executable program and modules as a non-transitory computer-readable storage medium, such as corresponding program instructions/modules for the methods for slicing a streaming media file mentioned by embodiments of the present disclosure (such as shown in FIG. 4, first scheduling unit 41 and second scheduling unit 42). Processor 101 performs kinds of functions and slicing a streaming media file of the electronic device by executing non-transitory software program, instructions and modules which are stored in memory 102, thereby realizes the methods for slicing a streaming media file mentioned by embodiments of the present disclosure.

Memory 102 can include program storage area and data storage area, thereby the operating system and applications required by at least one function can be stored in program storage area and data created by using the device for slicing a streaming media file can be stored in data storage area. Furthermore, memory 102 can include high speed Random-access memory (RAM) or non-volatile memory such as magnetic disk storage device, flash memory device or other non-volatile solid state storage devices. In some embodiments, memory 102 can include long-distance setup memories relative to processor 101, which can communicate with the device for slicing a streaming media file by networks. The examples of said networks are including but not limited to Internet, Intranet, LAN, mobile Internet and their combinations.

Input unit 103 can be used to receive inputted number, character information and key signals causing user configures and function controls of the device for slicing a streaming media file. Output unit 104 can include a display screen or a display device.

The said module or modules are stored in memory 102 and perform the methods for slicing a streaming media file when executed by one or more processors 101.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for slicing a streaming media file, implemented by a control center, comprising:
scheduling a slicing task onto a master server to execute the slicing task; and
scheduling the slicing task being executed by the master server onto a backup server to continue executing if the master server stops slicing.

2. The method according to claim 1, wherein before the scheduling a slicing task onto a master server to execute the slicing task, the method further comprises:
grouping slicing servers, wherein each group comprises at least two slicing servers; and
determining one slicing server in each group to be a master server and other slicing servers in each group to be backup servers.

3. The method according to claim 1, wherein the scheduling the slicing task being executed by the master server onto a backup server to continue executing comprises:
detecting whether the master server stops slicing; and
scheduling the slicing task being executed by the master server onto the backup server to continue executing if a detection result is yes.

4. The method according to claim 3, wherein the detecting whether the master server stops slicing comprises:
receiving an exception notification reported by the master server, wherein the exception notification is used for indicating that the master server stops slicing; or
sending periodically a keepalive test request to the master server, and determining that the master server stops slicing if no keepalive response returned by the master server is received.

5. The method according to claim 1, wherein when the master server executes a slicing task, a slicing result generated by the master server is backed up into the backup server so that the backup server continues executing slicing according to the slicing result when the slicing task is scheduled onto the backup server for executing.

6. The method according to claim 5, wherein the slicing result carries sequence number information of fragmentation and fragmentation duration information so that the backup server continues slicing according to the sequence number information and the fragmentation duration information.

7. An electronic device, comprising:
at least one processor; and
a memory communicably connected with the at least one processor for storing instructions executable by the at least one processor, wherein execution of the instructions by the at least one processor causes the at least one processor to:
schedule a slicing task onto a master server to execute the slicing task; and
schedule the slicing task being executed by the master server onto a backup server to continue executing if the master server stops slicing.

8. The electronic device according to claim 7, wherein before the scheduling a slicing task onto a master server to execute the slicing task, the instructions are executed to cause the at least one processor to:
group slicing servers, wherein each group comprises at least two slicing servers; and
determine one slicing server in each group to be a master server and other slicing servers in each group to be backup servers.

9. The electronic device according to claim 7, wherein the scheduling the slicing task being executed by the master server onto a backup server to continue executing comprises:
detecting whether the master server stops slicing; and
scheduling the slicing task being executed by the master server onto the backup server to continue executing if a detection result is yes.

10. The electronic device according to claim 9, wherein the detecting whether the master server stops slicing comprises:
receiving an exception notification reported by the master server, wherein the exception notification is used for indicating that the master server stops slicing; or
sending periodically a keepalive test request to the master server, and determining that the master server stops slicing if no keepalive response returned by the master server is received.

11. The electronic device according to claim 7, wherein when the master server executes a slicing task, a slicing result generated by the master server is backed up into the backup server so that the backup server continues executing slicing according to the slicing result when the slicing task is scheduled onto the backup server for executing.

12. The electronic device according to claim 11, wherein the slicing result carries sequence number information of fragmentation and fragmentation duration information so that the backup server continues slicing according to the sequence number information and the fragmentation duration information.

13. An electronic device, comprising:
at least one processor; and
a memory communicably connected with the at least one processor for storing instructions executable by the at least one processor, wherein execution of the instructions by the at least one processor causes the at least one processor to:
receive a scheduling instruction sent by a control center, wherein the scheduling instruction is used for instructing the backup server to continue executing a slicing task being executed on a master server; and
continue executing the slicing task scheduled from the master server in response to the scheduling instruction.

14. The electronic device according to claim 13, wherein before the receiving a scheduling instruction sent by a control center, the instructions are executed to cause the at least one processor to:
back up a slicing result generated by the master server when the master server executes the slicing task; and
the continuing executing the slicing task scheduled from the master server comprises:
continuing executing the slicing task according to the slicing result.

15. The electronic device according to claim 14, wherein the slicing result carries sequence number information of fragmentation and fragmentation duration information; and
the continuing executing the slicing task according to the slicing result comprises:
continuing slicing according to the sequence number information and the fragmentation duration information.
